(19) United States
(12) Patent Application Publication
(10) Pub. No.: US 2002/0005462 A1
(43) Pub. Date: Jan. 17, 2002

(54) Deployment system for a moveable wing surface

(76) Inventor: Michael Craig Broadbent, Brownswood (GB)

Correspondence Address: FAY, SHARPE, FAGAN, MINNICH & McKEE, LLP, 1100 Superior Avenue - 7th Floor, Cleveland, OH, 44114-2518, US

(21) Appl. No.: 09/860,000

(22) Filed: May 17, 2001

(30) Foreign Application Priority Data
May 20, 2000 (GB) GB 0012176.4

(51) Int. Cl. B64C 3/50

(52) U.S. Cl. 244/214

(57) ABSTRACT

A deployment system for deploying a moveable wing surface such as a slat from a main wing section includes a first swing arm assembly (24) and a second swing arm assembly (26), which connect the moveable wing surface (22) to said main wing section (8). The first swing arm assembly (24) includes a first swing arm (30) that is pivotably connected to the moveable wing surface, and the second swing arm assembly (26) includes a second swing arm (44) that is connected to the moveable wing surface (22) via a lost motion mechanism (50) that includes a sliding joint (58).

The present invention relates to a system for deploying moveable wing surfaces, for example aircraft slats and flaps.

Slat and flap systems provide the ability to vary the camber of a wing, to optimise flight conditions at cruise, take-off and landing: low camber provides low drag for cruising and high camber allows for low speed take-off and landing.

Various mechanisms have been proposed for deploying slats and flaps including paired track systems, Kruger flap systems and swing arm systems. The present invention relates to a swing arm system, for example of the general type described in International patent application No: PCT/NZ95/00096. The swing arm system may be used for deploying slats or flaps and in the following description references to slat deployment systems are intended to include flap deployment systems, and vice versa.

In prior art swing arm slat deployment systems such as that described in the above-mentioned patent application, each swing arm generally swings through an arc of approximately 70° from a retracted position in which the arm subtends an angle of approximately 20° with the leading edge of the wing, to a fully deployed position in which it is approximately perpendicular to the leading edge. Owing the limited arc through which the arms swing, relatively long arms are needed to generate the necessary separation between the slat and the main wing section when the slat is fully deployed. The arms are therefore relatively heavy.

In prior art swing arm slat deployment systems such as that described in the above-mentioned patent application, normally only one of the swing arms is driven, the undriven swing arm simply following the movement of the driven arm owing to its connection to that arm through the slat. This avoids mechanical stresses in the slats and the swing arms which might otherwise occur, for example when the slat and the wing experience different degrees of thermal expansion during flight. However, the arrangement suffers from the disadvantage that the undriven arm is not closely controlled, which can result in a gap being left between the slat and the main wing section when the slat is in a stowed position.

Most wings taper from root to tip, and therefore the variable camber device should mimic this taper to give full benefit along the length of the wing.

Further, it is safety requirement that no slat can deploy or retract on its own as a result of a single failure. Any single failure should not cause further failures and, if possible, any failure of the mechanism should be communicated to the cockpit.

It is an object of the present invention to provide a deployment system for moveable wing surfaces that mitigates at least some of the afore-mentioned disadvantages.

The inventor has realised that by designing the deployment system so that the swing arms rotate through a larger arc, for example of 90° or more, the required separation between the slat and the main wing section can be generated using shorter and lighter swing arms.

In order for this system to work correctly, it is essential that both swing arms are driven. If only one of the swing arms was driven, the undriven arm would receive no driving effect from the driven arm when the two arms were aligned, which could make it difficult to move the slat from that position.

However, if both swing arms are driven, the mechanism becomes susceptible to mechanical stress as described above and could also under certain circumstances become jammed with one swing arm slightly in front of the line that passes through the pivot joints and the other swing arm slightly behind that line. This risk may be heightened when, for example, the slat and the wing experience different amounts of thermal expansion, or when the mechanical components in the slat mechanism are worn or do not meet required manufacturing tolerances. Locking of the swing arms could prevent the slat from deploying fully or cause it to become stuck in a partially-deployed position with potentially dangerous results.

According to the present invention, there is provided a deployment system for deploying a moveable wing surface from a main wing section, the deployment system including at least one first swing arm assembly and at least one second swing arm assembly connecting said moveable wing surface to said main wing section, said first swing arm assembly including a first swing arm that is pivotably connected to the moveable wing surface, and said second swing arm assembly including a second swing arm that is connected to said moveable wing surface via a lost motion mechanism, said lost motion mechanism including a sliding joint.

The lost motion mechanism in the second swing arm assembly compensates for thermal expansion or contraction of the moveable wing surface without transmitting stresses to the main wing section, and prevents jamming of the deployment system. The sliding joint is mechanically very simple and reliable.

Advantageously, both swing arms are driven. This provides for close control over the movement of the slat and ensures that any gaps between the slat and the main wing section when the slat is in the stowed position are minimised.

Advantageously, the sliding joint mechanism allows sliding movement between the second swing arm and the moveable wing surface in the axial direction of the slat.

Advantageously, the first and second swing arms are arranged to swing through an angle of 90°-120°, preferably approximately 90°.

Increasing the arc through which the swing arms rotate makes it possible to reduce their length and weight.

Advantageously, the deployment system includes a shutter mechanism for sealing an aperture in the wing leading edge when the slat is deployed. The shutter mechanism may include a shutter plate mounted on swing arms, and may be linked to at least one of the slat swing arms for movement therewith. The shutter mechanism seals the leading edge when the slat is deployed, improving the aerodynamic performance of the wing and preventing the ingress of dirt, debris, ice and water.

Advantageously, the deployment system includes a shroud mechanism for sealing an aperture in the wing leading edge when the slat is retracted. The shroud mechanism may include a shroud plate mounted on a slat swing arm for movement therewith. The shroud mechanism seals the leading edge when the slat is retracted, improving the aerodynamic performance of the wing and preventing the ingress of dirt, debris, ice and water. The shroud mechanism is particularly useful on thin wings, for example of supersonic aircraft.

Advantageously, the deployment system includes a sensor for sensing failure of the deployment system. The sensor may be constructed and arranged to sense movement of the sliding joint beyond predetermined limits. If both swing arms of the slat are driven, any failure will cause the lost motion mechanism to move to one or other of its ends. This can be sensed by a sensor such as microswitch placed just beyond the normal limits of travel. Any failure can thus be sensed and communicated to the cockpit and/or to an electronic control device for controlling the slat system, thereby preventing further damage being caused by subsequent system activity.

Advantageously, the moveable wing surface is a slat.

Embodiments of the invention will now be described, by way of example, with reference to the accompanying drawings, in which:

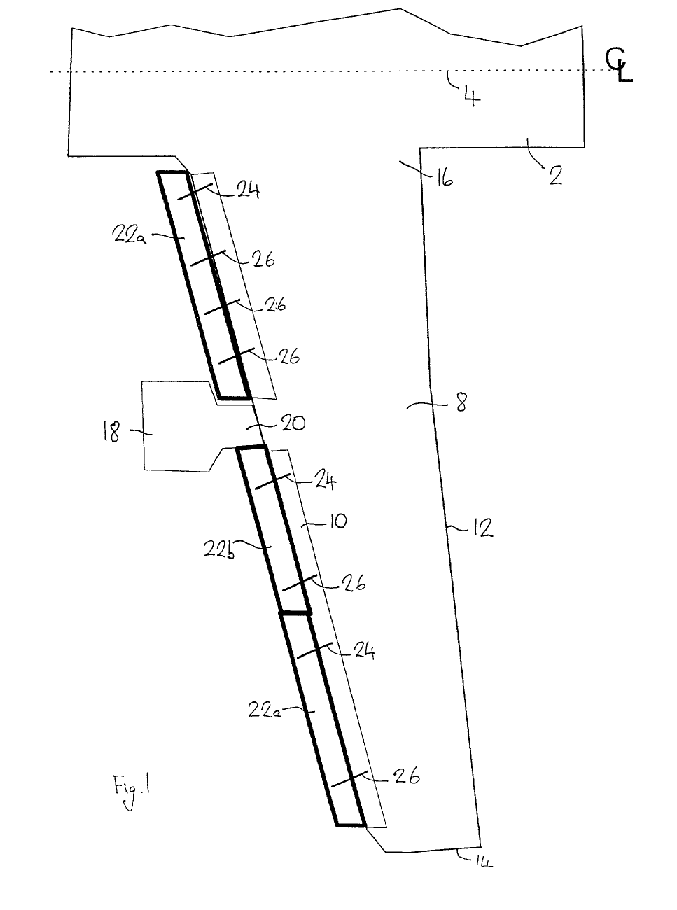

FIG. 1 shows diagrammatically a plan view of a wing with three slats at the leading edge separated by an engine pylon;

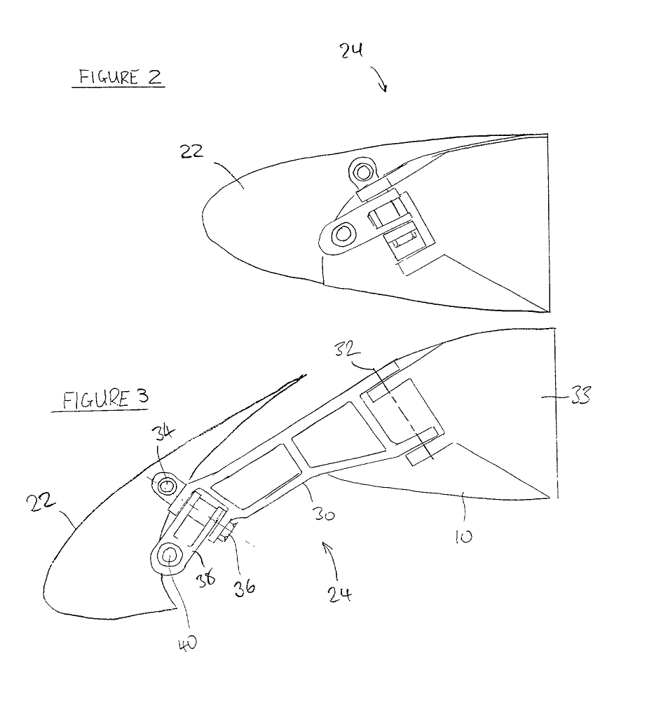

FIG. 2 is a side view of a first swing arm assembly in a retracted position;

FIG. 3 is a side view of the first swing arm assembly in a deployed position;

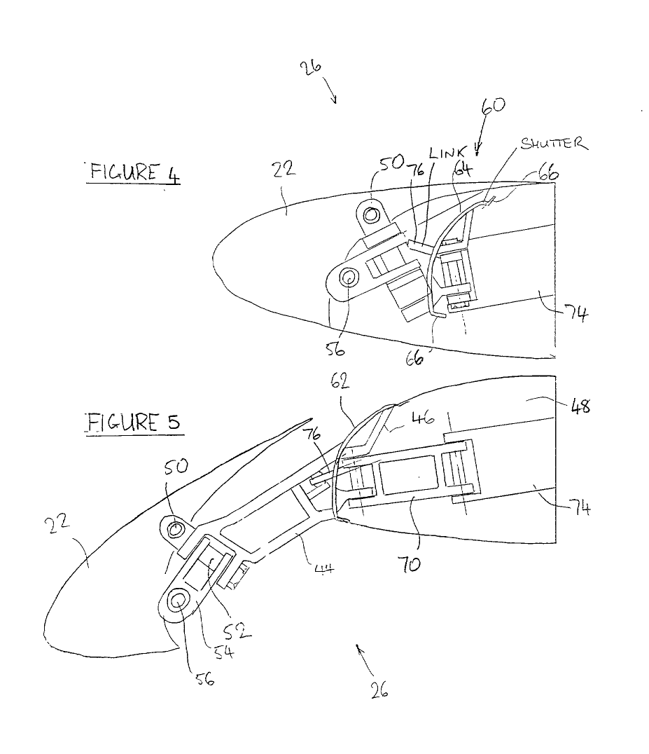

FIG. 4 is a side view of a second swing arm assembly in a retracted position;

FIG. 5 is a side view of the second swing arm assembly in a deployed position;

FIG. 6 is plan view of the second swing arm assembly in a retracted position;

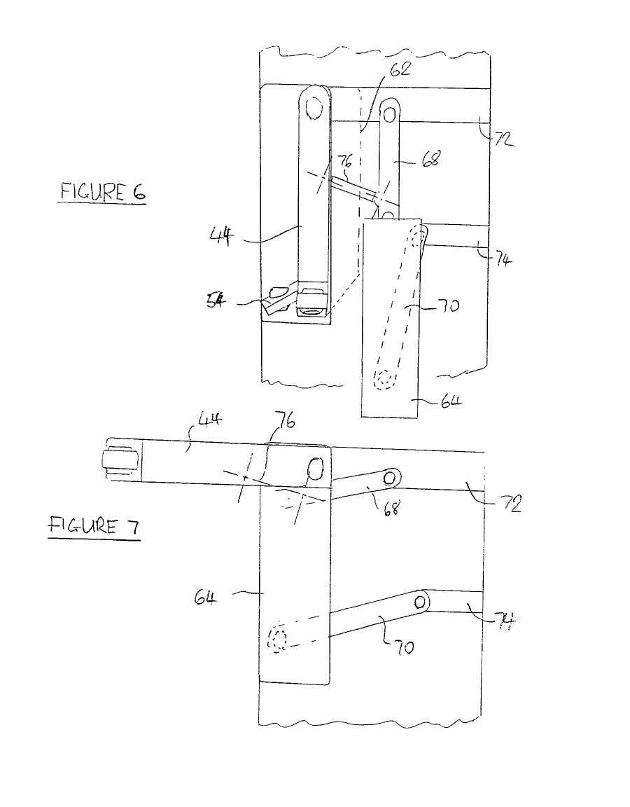

FIG. 7 a plan view of the second swing arm assembly in a deployed position;

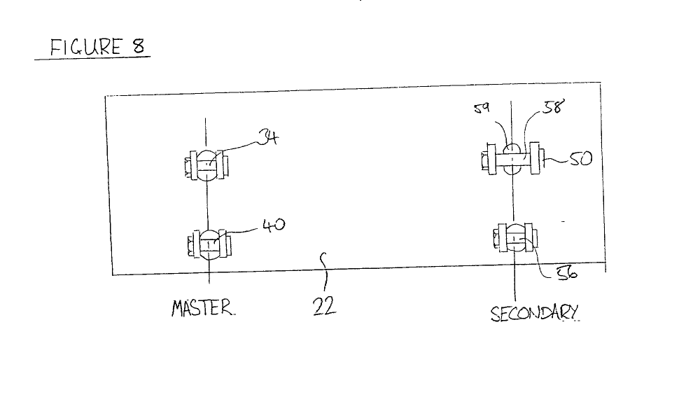

FIG. 8 is rear view of a slat;

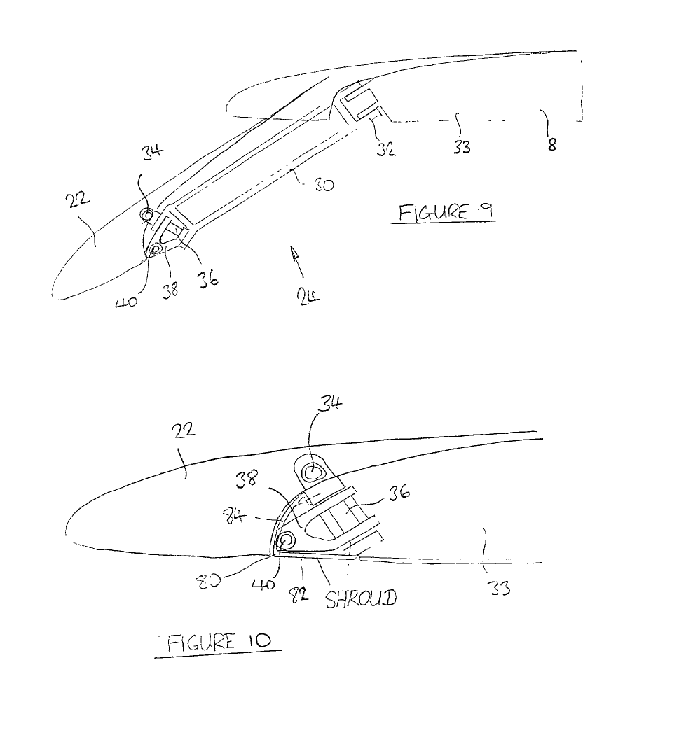

FIG. 9 is a side view of a swing arm assembly according to a second embodiment of the invention, shown in a deployed position;

FIG. 10 is a side view of the swing arm assembly of FIG. 9, shown in a retracted position;

FIG. 11 is a side view of a swing arm assembly according to a third embodiment of the invention, shown in a retracted position;

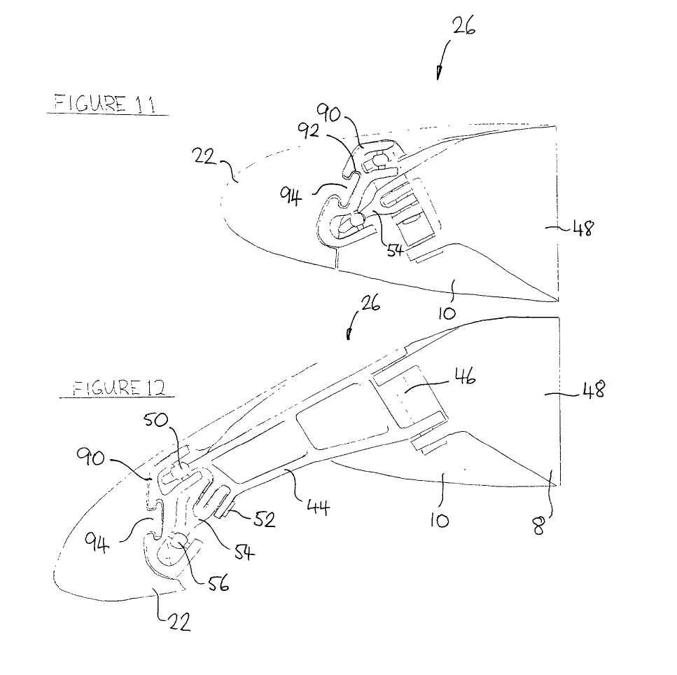

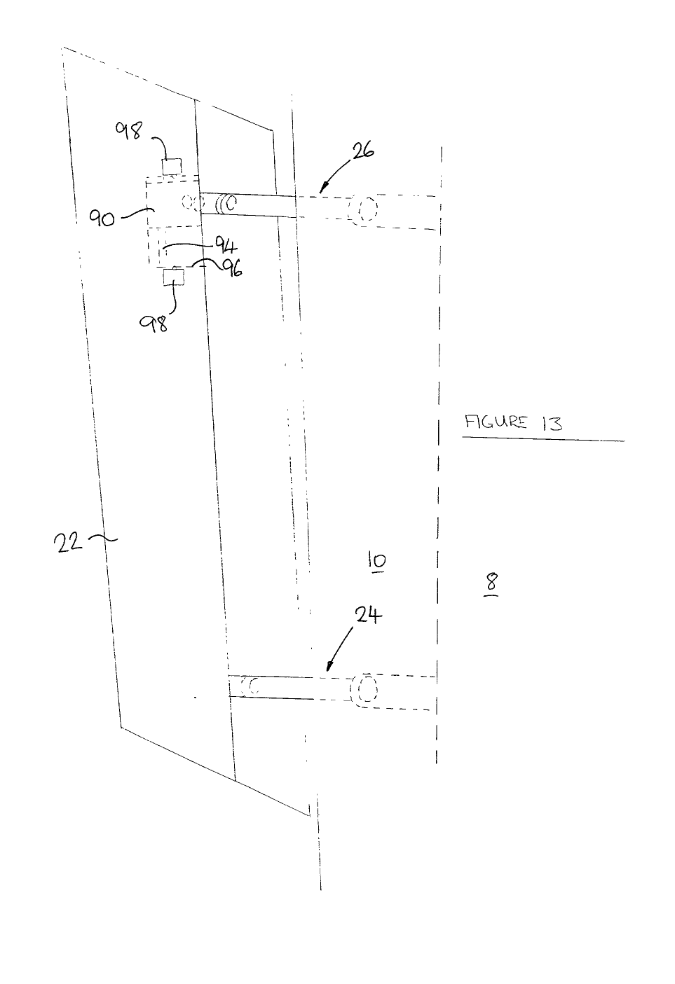

FIG. 12 is a side view of the swing arm assembly of FIG. 11, shown in a deployed position, and

FIG. 13 a plan view of the swing arm assembly of FIG. 11, shown in a deployed position.

Referring first to FIG. 1, the aircraft has a fuselage 2 with a centre line 4. In the drawing, only the port wing is shown: this includes a main wing section 8 having a leading edge 10, a trailing edge 12, a wing tip 14 and a root 16. The wing is tapered, the chord decreasing from the root 16 to the tip 14. An engine 18 is attached to the underside of the main wing section 8 by means of a pylon 20.

A plurality of slats 22 are attached to the leading edge of the wing. In the example shown in the drawing, there are three slats, an inner slat 22a, a middle slat 22b and an outer slat 22c. The slats 22 are attached to the leading edge 10 of the wing by means of swing arm assemblies 24,26. There are two types of swing arm assembly: a first type 24 and second type 26. Each slat has at least one swing arm assembly of the first type 24, which is located towards the inner end of the slat, and one or more of the second type 26, located towards the centre or the outer end of the slat 22.

The first swing arm assembly 24 is shown in more detail in FIGS. 2 and 3. The assembly includes a first swing arm 30 that is attached at one end by means of a first pivot joint 32 to a structural member 33 within the leading edge envelope 10 of the main wing section 8, and at the other end to the slat 22 by means of a second pivot joint 34, which is rotatably attached to the end of the first swing arm 30 by means of an orthogonal third pivot joint 36. The pivot axis of the first pivot joint 32 is inclined forwards so that as the slat 22 is deployed, it is translated forwards and downwards relative to the wing leading edge. The pivot axis of the second pivot joint 34 extends substantially parallel to the longitudinal axis of the slat 22 (as shown in FIG. 8). The slat 22 can rotate or tilt about this axis between the positions shown in FIGS. 2 and 3.

A control arm 38 is attached to the slat end of the swing arm 30, by means of the third pivot joint 36, and to the slat 22 by means of a fourth pivot joint 40. The control arm 38 controls the angle of the slat 22 relative to the main wing section 8. The axes of the first and third pivot joints 32,36 are inclined relative to one another, so that as the slat 22 is deployed, it is tilted forwards at the same time as being translated forwards and downwards relative to the wing leading edge. The first swing arm assembly also includes a drive mechanism (not shown) for driving the swing arm 30 for rotation about the first pivot joint 32.

The second swing arm assembly 26 is shown in more detail in FIGS. 4 and 5. The assembly is mechanically similar to that of the first swing arm assembly 24 and includes a second swing arm 44 that is connected by means of a fifth pivot joint (not shown) having a pivot axis 46 to a structural member 48 in the wing leading edge 10, the other end of the swing arm 44 being connected to the slat 22 via a sixth pivot joint 50, which is rotatably attached to the end of the second swing arm 44 by means of an orthogonal seventh pivot joint 52. The pivot axis 46 of the fifth pivot joint is inclined forwards so that as the slat 22 is deployed, it is translated forwards and downwards relative to the wing leading edge. The pivot axis of the sixth pivot joint 50 extends substantially parallel to the longitudinal axis of the slat 22 and includes a sliding joint mechanism (shown in FIG. 8) that permits axial movement between the slat and the swing arm. The slat 22 can rotate or tilt about the sixth pivot axis 50 between the positions shown in FIGS. 4 and 5.

A control arm 54 is attached to the slat end of the second swing arm 44, by means of the seventh pivot joint 52, and to the slat 22 by means of an eighth pivot joint 56. The control arm 54 controls the angle of the slat 22 relative to the main wing section 8. The axes of the fifth and seventh pivot joints 46, 52 are inclined relative to one another, so that as the slat 22 is deployed, it is tilted forwards at the same time as being translated forwards and downwards relative to the wing leading edge. The second swing arm assembly also includes a drive mechanism (not shown) for driving the swing arm 44 for rotation about the fifth pivot joint 46.

The second swing arm 44 is slightly shorter than the first swing arm 30 so that when the slat 22 is deployed, the separation between the slat and the wing leading edge is slightly larger at the inner end of the slat than it is at the outer end of the slat. This provides an ideal configuration, the distance between the slat and the wing preferably being proportional to the chord of the wing at that point.

The sliding joint mechanism provided in the sixth pivot joint 50 consists of an over-length pivot pin 58 that extends through a mounting point 59 on the slat 22. The mounting point 59 can slide along the pin 58 and this serves as a lost motion mechanism allowing a degree of lateral movement between the second swing arm 44 and the slat 22 in the direction of the wing leading edge. However, no lateral movement is allowed by the first swing arm assembly 24. The lateral movement allowed by the second swing arm assembly 26 compensates for thermal expansion or contraction of the slat during flight, without transferring stresses to the main wing section. It also compensates for wear in the joints and for manufacturing tolerances in the components of the system. This prevents the slat from jamming when, for example, the swing arms are aligned.

Further, the lost motion mechanism allows for the different lateral movements of the different length swing arms and facilitates an ideal configuration.

The second swing arm assembly 26 includes a shutter assembly 60, shown in FIGS. 4 to 7, for sealing the aperture 62 that is provided in the leading edge of the main wing section 10 to allow the second swing arm 44 to extend forwards from the wing. The shutter assembly includes a curved shutter plate 64 that matches the profile of the leading edge and has sealing members 66 around its periphery that engage the inner surface of the wing envelope to provide an effective seal against the ingress of dirt, debris, ice and water.

The shutter plate 64 is mounted on first and second shutter swing arms 68,70, the rear ends of which are attached to structural members 72,74 in the wing leading edge 10. The first shutter swing arm 68 is shorter than the second shutter swing arm 70 and is mounted further forward. This mitigates against the possibility of jamming, as only one swing arm is driven.

The first shutter swing arm 68 is connected to the second slat swing arm 44 by means of a pivot link 76. The shutter plate 64 therefore follows the movement of the slat 22, advancing and retreating as the slat is deployed and retracted. The shutter assembly 60 does not therefore require a separate drive mechanism.

To deploy the slat 22, the drive mechanisms for the first and second swing arm assemblies are actuated, causing the first swing arm 30 and the second swing arm 44 to pivot through an angle of approximately 90° from the retracted positions shown in FIGS. 2, 4 and 6 in which they are approximately parallel to the wing leading edge to the deployed positions shown in FIGS. 3, 5 and 7 in which they are approximately perpendicular to the leading edge. This causes the slat 22 to swing forwards from a retracted position to a fully deployed position. The shutter plate 64 follows the movement of the slat 22, sealing the aperture 62 in the leading edge of the main wing section 10 as the slat is deployed.

A second embodiment of the slat deployment system that is designed for use with thin wings, for example on supersonic aircraft, is shown in FIGS. 9 and 10. The system is similar in many respects to the first system described above and where appropriate the same reference numbers have been used.

The system includes first and second swing arm assemblies, of which only the first swing arm assembly 24 is shown. The assembly includes a first swing arm 30 that is attached at one end by means of a first pivot joint 32 to a structural member 33 within the leading edge envelope of the main wing section 8, and at the other end to the slat 22 by means of a second pivot joint 34, which is rotatably attached to the first swing arm 30 by means of an orthogonal third pivot joint 36. The pivot axis of the first pivot joint 32 is inclined forwards so that as the slat 22 is deployed, it is translated forwards and downwards relative to the wing leading edge. The pivot axis of the second pivot joint 34 extends substantially parallel to the longitudinal axis of the slat 22. The slat 22 can rotate or tilt about this axis between the positions shown in FIGS. 9 and 10.

A control arm 38 is attached to the slat end of the swing arm 30, by means of the third pivot joint 36, and to the slat 22 by means of a fourth joint 40. The control arm 38 controls the angle of the slat 22 relative to the main wing section 8. The axes of the first and third pivot joints 32,36 are inclined relative to one another, so that as the slat 22 is deployed, it is tilted forwards at the same time as being translated forwards and downwards relative to the wing leading edge. The swing arm assembly also includes a drive mechanism (not shown) for driving the swing arm 30 for rotation about the first pivot joint 32.

An elongate shroud 80, shown in FIG. 10, is attached to and extends along the lower edge of the swing arm 30, to move with the swing arm as the slat is deployed and retracted. The shroud 80 is shaped to match the profile of the leading edge of the main wing section and includes a substantially flat bottom plate 82 the matches the underside of the wing and a curved front plate 84. The shroud seals the aperture in the leading edge when the slat 22 is in a retracted position, this aperture resulting from the fact that in the thin wing section the swing arm has to pass through the lower surface of the wing when the slat is deployed.

It will be noted that when the slat is retracted, the swing arm 30 extends parallel to the wing leading edge, so that the shroud correctly fits the aperture in the leading edge.

A similar shroud may be attached to the swing arm of the second swing arm assembly (not shown), which in other respects is mechanically similar to the second swing arm assembly of the first deployment system described above. Optionally, one or both of the swing arm assemblies may also include a shutter assembly similar to that described above for sealing the aperture in the leading edge when the slat 22 is deployed.

A third embodiment of the slat deployment system is shown in FIGS. 11 to 13. The system is similar in many respects to the first slat deployment system described above and where appropriate the same reference numbers have been used.

The system includes first and second swing arm assemblies, of which only the second swing arm assembly 26 is shown in FIGS. 11 and 12. The first swing arm assembly 24 is substantially identical to that of the first slat deployment system described above and will not, therefore, be described here.

The second swing arm assembly 26 includes a swing arm 44 that is connected by means of a fifth pivot joint 46 to a structural member 48 in the wing leading edge 10, the other end of the swing arm 44 being connected to a sliding plate 90 via a sixth pivot joint 50. The sliding plate 90 includes a T-shaped slot 92 that extends substantially parallel to the axis of the slat 22, and is engaged by a corresponding T-shaped rib formation 94 provided in a recess 96 on inner surface of the slat 22. Sensors 98, for example microswitches, are provided at each end of the recess 96 to detect the position of the plate 90. The rib and slot form a lost motion mechanism that allows relative sliding movement between the slat 22 and the plate 90 in the axial direction of the slat.

The pivot axis of the fifth pivot joint 46 is inclined forwards so that as the slat 22 is deployed, it is translated forwards and downwards relative to the wing leading edge. The slat 22 can rotate or tilt with the plate 90 about the sixth pivot axis 50 between the positions shown in FIGS. 11 and 12.

A control arm 54 is attached to the slat end of the swing arm 44, by means of a seventh pivot joint 52, and to the plate 90 by means of an eighth pivot joint 56. The control arm 54 controls the angle of the slat 22 relative to the main wing section 8. The axes of the fifth and seventh pivot joints 46, 52 are inclined relative to one another, so that as the slat 22 is deployed, it is tilted forwards at the same time as being translated forwards and downwards relative to the wing leading edge. The second swing arm assembly also includes a drive mechanism (not shown) for driving the swing arm 44 for rotation about the fifth pivot joint 46.

The sliding plate 90 provided in the second swing arm assembly 26 serves as a lost motion mechanism allowing a degree of lateral movement between the second swing arm 44 and the slat 22 in the direction of the wing leading edge. However, no lateral movement is allowed by the first swing arm assembly 24. The lateral movement allowed by the second swing arm assembly 26 compensates for thermal expansion or contraction of the slat during flight, without transferring stresses to the main wing section. It also compensates for wear in the joints and for manufacturing tolerances in the components of the system. This prevents the slat from jamming when, for example, the swing arms are aligned. It also allows different length swing arms, such as are required for tapered slats.

Various modifications of the deployment mechanism are possible, some examples of which will now be described. A shutter mechanism may be associated with both of the swing arm assemblies, to seal both apertures in the wing leading edge. The swing arms may be arranged to pivot through an angle of more than 90°, for example up to 120°.

1. A deployment system for deploying a moveable wing surface from a main wing section, the deployment system including at least one first swing arm assembly and at least one second swing arm assembly connecting said moveable wing surface to said main wing section, said first swing arm assembly including a first swing arm that is pivotably connected to the moveable wing surface, and said second swing arm assembly including a second swing arm that is connected to said moveable wing surface via a lost motion mechanism, said lost motion mechanism including a sliding joint.

2. A deployment system according to claim 1, in which both the first swing arm assembly and the second swing arm assembly are driven.

3. A deployment system according to claim 1, in which the sliding joint mechanism allows sliding movement between the second swing arm and the moveable wing surface substantially in the axial direction of the moveable wing surface.

4. A deployment system according to claim 1, in which the first and second swing arms are arranged to swing through an angle of 90°-120°, preferably approximately 90°.

5. A deployment system according to claim 1, including a shutter mechanism for sealing an aperture in the wing leading edge when the moveable wing surface is deployed.

6. A deployment system according to claim 5, in which the shutter mechanism includes a shutter plate mounted on at least one third swing arm.

7. A deployment system according to claim 5, in which the shutter mechanism is linked to at least one of said first and second swing arms for movement therewith.

8. A deployment system according to claim 1, including a shroud mechanism for sealing an aperture in the wing leading edge when the moveable wing surface is retracted.

9. A deployment system according to claim 8, in which the shroud mechanism includes a shroud plate mounted on at least one of said first and second swing arms for movement therewith.

10. A deployment system according to claim 1, including a sensor for sensing failure of the deployment system.

11. A deployment system according to claim 10, in which the sensor is constructed and arranged to sense movement of the sliding joint beyond predetermined limits.

12. A deployment system according to claim 1, in which the moveable wing surface is a slat.
